(19) United States
(12) Patent Application Publication
(10) Pub. No.: US 2016/0129568 A1
(43) Pub. Date: May 12, 2016

(54) IMPACT TOOL

(71) Applicant: HITACHI KOKI CO., LTD., Minato-ku, Tokyo (JP)

(72) Inventors: Tomomasa Nishikawa, Ibaraki (JP); Tetsuhiro Harada, Ibaraki (JP)

(21) Appl. No.: 14/893,140

(22) PCT Filed: Jun. 25, 2014
(86) PCT No.: PCT/JP2014/067600

§ 371 Date: Nov. 23, 2015

(30) Foreign Application Priority Data
Jul. 26, 2013 (JP) 2013-156181

(51) Int. Cl. B25B 21/02

(52) U.S. Cl. CPC B25B 21/02

(57) ABSTRACT

An impact tool includes a hammer that is moved in an axis direction while being rotated by an action of a cam mechanism provided for a spindle and an anvil to which a rotational force and a striking force are applied by the hammer. A rear end surface of a striking part of the hammer is obliquely formed and has two mountain-shaped inclined surfaces. A striking part of the anvil is formed with two mountain-shaped inclined surfaces. By the inclined surfaces, even when the motor is stopped at a state where the hammer gets on the anvil, the hammer is moved forwards in the axis direction by an action of a spring and is then stopped.

### TECHNICAL FIELD

The present invention relates to an impact tool, and more particularly, to improvements on shapes of a hammer and an anvil of an impact tool having a plurality of operating modes and a control method thereof.

### BACKGROUND ART

An impact tool is a tool used for a fastening operation of a screw and a bolt, a strike mechanism part is configured by a hammer and an anvil, and the hammer is rotated with moving forwards and rearwards to thus strike the anvil, thereby implementing high fastening torque. In recent years, regarding the impact tool performing the fastening operation while striking the anvil by the hammer, a new impact tool performing the striking only in a rotation direction without moving the hammer in an axis direction of rotation has been known as an “electronic pulse driver”, which is a product of the applicant. As disclosed in PTL 1, the electronic pulse driver is a tool performing the fastening operation in the same manner as the related-art impact tool performing an impact operation while the hammer is axially retreated, and rotates the hammer in forward and reverse directions by rotating a motor in forward and reverse directions while the hammer does not get on the anvil, thereby applying a striking force to the anvil. For this reason, the electronic pulse driver does not strike a material to be fastened in an axis direction of the fastening, so that a noise is reduced. However, the electronic pulse driver has a disadvantage that it is unable to sequre a high fastening torque compared to the related-art impact tool performing the impact operation while the hammer is axially retreated.

In order to solve the above problem, PTL 2 discloses a fastening tool that is provided with a switching mechanism part, which restrains the hammer from running on the anvil in the related-art impact tool, in a hammer case. The fastening tool has an operating mode of performing the impact operation while the hammer is axially retreated and an operating mode of performing the striking by a rotation control only in the rotation direction without retreating the hammer, and is configured to operate as the impact tool and the electronic pulse driver by switching the operation modes.

### CITATION LIST

### Patent Literature

PTL 1: JP-A-2011-31313

PTL 2: JP-A-2012-11502

### SUMMARY OF INVENTION

### Technical Problem

According to the technology of PTL 2, the switching mechanism switching the impact tool and the electronic pulse driver is provided. At a setting state where the hammer can get on the anvil, an impact operation is performed in the same “impact mode” as the related-art technology, and at a setting state where the hammer cannot get on the anvil, an impact operation is performed in a so-called “electronic pulse mode”. Therefore, it is possible to set the operating mode, depending on a required magnitude of the fastening torque. However, when stopping the motor while the impact operation is performed in the impact mode, the hammer may be stopped at a state where a claw of the hammer gets on a claw of the anvil. At this state, even when an operator tries to operate the switching mechanism so as to switch the operating mode, the switching mechanism is not moved due to the hammer getting on the anvil, so that the switching cannot be made.

The present invention has been made in view of the above situations, and one object of the present invention is to provide an impact tool, which has a hammer retreat-moveable relative to an anvil and a switching mechanism capable of blocking the retreat movement of the hammer, and which can prevent the hammer from stopping at a state where a claw of the hammer gets on a claw of the anvil.

Another object of the present invention is to release the state where the claw of the hammer gets on the claw of the anvil upon stop of a motor 3, without using a new driving source, by changing shapes of the claws of the hammer and anvil.

Still another object of the present invention is to provide an impact tool that is controlled to automatically rotate a motor by a slight angle when a trigger is returned, so as for the hammer not to stop at the state where the claw of the hammer gets on the claw of the anvil.

### Solution to Problem

Representative features of the present invention disclosed in the specification are described as follows.

According to one illustrative aspect of the present invention, there is provided an impact tool comprising: a motor; a spindle that is rotated by the motor; a hammer that is moved in an axis direction of the spindle while being rotated by an action of a cam mechanism provided for the spindle; an anvil to which a rotational force and a striking force are applied by the hammer, and a spring configured to urge the hammer towards the anvil, characterized in that facing surfaces of a striking part of the hammer and a striking part of the anvil in a direction of a rotation axis of an output shaft are respectively formed to be circumferentially oblique relative to a plane perpendicular to the rotation axis. According thereto, since the facing surfaces of the hammer and the anvil are obliquely formed, even when rotation of the motor is stopped at a state where the hammer gets on the anvil, the hammer is always moved forwards by the action of the spring and is then stopped.

According to another illustrative aspect of the present invention, there is provided an impact tool comprising: a motor; a trigger rotating the motor; a spindle that is rotated by the motor; a hammer that is moved in an axis direction of the spindle while being rotated by an action of a cam mechanism provided for the spindle; an anvil to which a rotational force and a striking force are applied by the hammer; and a spring that urges the hammer towards the anvil, characterized in that the impact tool further comprises a control device configured to supply a short pulse voltage for driving the motor after a short time period from a release of the trigger. For this reason, it is possible to return the hammer from the getting-on state on the anvil by the electric control of the motor. Therefore, it is possible to effectively return the hammer from the getting-on state, depending on the rotation direction.

### Advantageous Effects of Invention

According to the present invention, when the motor is stopped during operation of the impact mode, even though the hammer intends to stop at a state where a claw part (the convex portion) of the hammer gets on a claw part (the protruding portion) of the anvil, since the abutting surfaces of the claw parts of the hammer and anvil are provided with the inclined surfaces, the anvil is rotated against a pressing force applied from the rear of the hammer towards the anvil, so that the claw part of the hammer can slide down from the claw part of the anvil. Therefore, it is possible to solve the problem that a lever operating a switching mechanism is not moved when switching the operating mode from the mechanical impact mode.

The above and other objects and novel features of the present invention can be clearly understood from the following descriptions and the drawings.

### BRIEF DESCRIPTION OF DRAWINGS

FIG. 1 is a longitudinally sectional view illustrating an overall configuration of an impact tool 1 according to an illustrative embodiment of the present invention.

FIG. 2 is a perspective view illustrating outward appearance shapes of a housing 2 and a hammer case 32 of FIG. 1.

FIG. 3 is an exploded perspective view illustrating an assembly structure of a hammer case, an impact mechanism part and a switching mechanism 35 of an impact tool of the related art.

FIG. 4 is a perspective view (a usual position) of a striking mechanism part and the switching mechanism 35 of the impact tool of the related art.

FIG. 5 is a perspective view (a lock position) of the striking mechanism part and the switching mechanism 35 of the impact tool of the related art.

FIGS. 6(1) and 6(2) are pictorial views for illustrating shapes of a stopper 41 and a pusher 45 of the switching mechanism 35 of the impact tool of the related art.

FIG. 7 illustrates a state where the hammer is stopped with a claw part of the hammer getting on a claw part of an anvil in the impact tool of the related art.

FIG. 8 illustrates improved shapes of a hammer 24 and an anvil 30 in an illustrative embodiment of the present invention.

FIGS. 9(1) to 9(4) illustrate movements of the hammer 24 and the anvil 30 of FIG. 8.

FIG. 10 is a perspective view illustrating shapes of the hammer 24 and the anvil 30 according to a second illustrative embodiment of the present invention.

FIG. 11 is a functional block diagram of a drive control system of a motor 3 of the impact tool 1.

FIGS. 12(1) to 12(3) illustrate a stop control of the hammer 24 in the second illustrative embodiment of the present invention, which shows a voltage to be applied to the motor 3 and a number of revolutions of the motor.

### DESCRIPTION OF EMBODIMENTS

### First Illustrative Embodiment

Hereinafter, illustrative embodiments of the present invention will be described with the drawings. In the drawings, the same parts are denoted with the same reference numerals and the overlapping descriptions thereof are omitted. Also, in the specification, the front-rear and upper-lower directions are described on the basis the directions shown in the drawings.

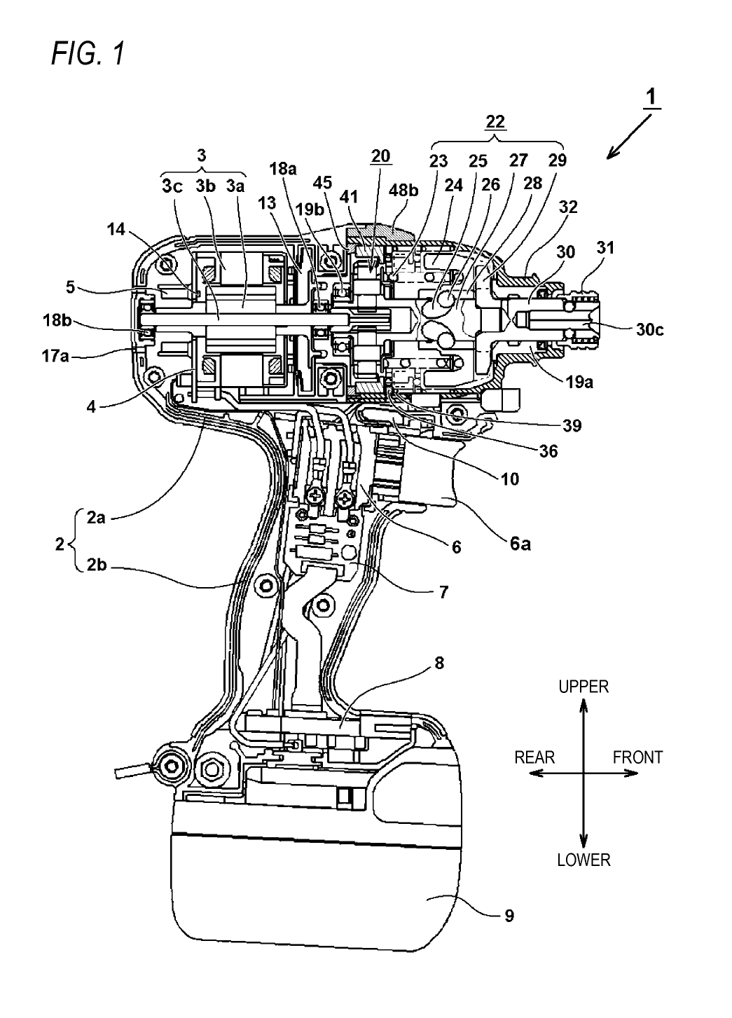

FIG. 1 illustrates an internal structure of an impact tool 1 according to an illustrative embodiment of the present invention. The impact tool 1 uses a chargeable battery 9 as a power source, drives a rotational striking mechanism part 22, and applies a rotational force and a striking force to an anvil 30, which is an output shaft, by using a motor 3 as a driving source, and intermittently transmits the rotational striking force to a tip tool (not shown) such as a driver bit held in an angled hole portion 30d covered by an attaching member 31, thereby performing an operation such as screw or bolt fastening.

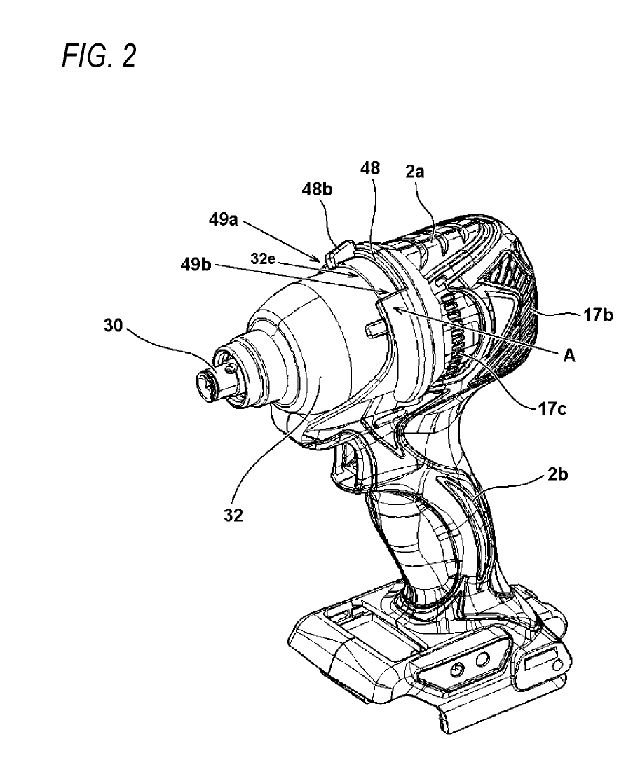

A housing of the impact tool 1 is configured by a housing 2 made of a synthetic resin material and a metallic case (a hammer case 32) that is attached to a front side of the housing 2 and a part thereof is covered with the housing 2. The hammer case 32 has a cup shape having an opening at a rear side thereof, and a bottom part (a front end part) thereof has a through-hole through which the output shaft passes. The motor 3 of a brushless DC-type is accommodated in a cylindrical trunk part 2a of the housing 2 having a substantial T-shape, when seen from the side. A rotation axis 3c of the motor 3 is rotatably held by a bearing 18a, which is provided near a center of the trunk part 2a of the housing 2, and a bearing 18b that is provided at a rear end-side thereof. A rotor fan 13 that is coaxially mounted with the rotation axis 3c and is rotated in synchronous with the motor 3 is provided in front of the motor 3. An inverter circuit board 4 for driving the motor 3 is arranged in the rear of the motor 3. Air flow generated by the rotor fan 13 is introduced into the trunk part 2a through an air inlet 17a and a slot 17b (refer to FIG. 2) (which will be described later) formed on a portion of the housing around the inverter circuit board 4. Then, the air flow mainly flows to pass through between a rotor 3a and a stator 3b, and is sucked form the rear of the rotor fan 13 to flow in a radial direction of the rotor fan 13, so that the air flow is discharged to the outside of the housing 2 through a slot 17c (refer to FIG. 2) which is formed on a portion of the housing around the rotor fan 13. The inverter circuit board 4 is a double-sided board having the substantially the same circular shape as an outer shape of the motor 3. A plurality of switching elements 5 such as FETs (Field Effect Transistors) and position detection elements 14 such as Hall ICs are mounted on the inverter circuit board.

A trigger switch 6, to which a trigger 6a is connected, is arranged on an upper part in a handle part 2b that extends substantially at a right angle from and integrally with the trunk part 2a of the housing 2. A switch board 7 is provided below the trigger switch 6. A control circuit board 8 that has a function to control the speed of the motor 3 by an operation of pulling the trigger 6a is accommodated at a lower part in the handle part 2b. The control circuit board 8 is electrically coupled to the battery 9 and to the switch circuit board 7. A circuit for controlling the driving of the motor 3 is mounted on the control circuit board 8. Below the handle part 2b, the battery 9 such as a nickel-cadmium battery, a lithium-ion battery or the like is detachably mounted.

In the trunk part 2a of the housing 2 and the hammer case 32, the motor 3 and a transmission mechanism part (a deceleration mechanism 20 and a rotational striking mechanism part 22) transmitting the power of the motor 3 to the tip tool are arranged side by side in an axis direction of the motor 3. An end portion of the anvil 30 protrudes from a tip of the hammer case 32 and is configured such that the tip tool, for example, a driver bit (not shown) is detachably inserted into the angled hole portion 30d and is fixed by one touch operation using the attaching member 31. A bolt fastening bit as another tip tool may be also mounted into the angled hole portion 30d.

The deceleration mechanism 20 having a planetary gear mechanism, which includes a planetary gear and a ring gear, and the rotational striking mechanism part 22 are provided in front of the trunk part 2a and in the hammer case 32. The rotational striking mechanism part 22 has a spindle 27 and a hammer 24. A rear end of a rotation mechanism configured by the deceleration mechanism 20 and the rotational striking mechanism part 22 is pivotally supported by the bearing 19b, and a front end of the rotation mechanism is held by a metal 19a. When the trigger 6a is pulled and the motor 3 is thus enabled to operate, the motor 3 starts to rotate in a direction set by a forward/reverse switching lever 10. The rotational force of the motor is decelerated by the deceleration mechanism 20 and transmitted to the spindle 27, so that the spindle 27 is rotationally driven at a predetermined speed. Here, the spindle 27 and the hammer 24 are connected by a known cam mechanism. The cam mechanism includes a V-shaped spindle cam recess 25 formed on an outer peripheral surface of the spindle 27, a hammer cam recess 28 formed on an inner peripheral surface of the hammer 24 and balls 26 that are engaged with the cam recesses 25, 28.

The hammer 24 is all the time urged forwards by a spring 23. When stationary, the hammer 24 is located at a position spaced from a rear end surface of the anvil 30 by engagement of the balls 26 and the cam recesses 25, 28. Convex portions (a claw part, a striking part) (not shown) are formed at two locations on a rotation plane of the hammer 24, which are opposed to with each other. Also, protruding portions (a claw part, a striking part) (not shown) are formed at two locations on a rotation plane of the anvil 30, which are opposed to with each other.

Upon screw fastening in the impact mode, the rotational force of the motor 3 transmitted from the rotation axis 3c is decelerated by the planetary gear and the ring gear included in the deceleration mechanism 20, and the decelerated rotational force is then transmitted to the spindle 27. When the spindle 27 is rotationally driven, the rotation of the spindle is transmitted to the hammer 24 through the cam mechanism. At this time, the convex portions of the hammer 24 are engaged with the protruding portions of the anvil 30 while the hammer 24 does not make a half turn, so that the anvil 30 is rotated. When relative rotation is generated between the spindle 27 and the hammer 24 due to an engagement reaction force at that time, the hammer 24 starts to retreat towards the motor 3 while compressing the spring 23 along the spindle cam recess 25 of the cam mechanism.

When the convex portions of the hammer 24 get beyond the protruding portions of the anvil 30 by the retreating movement of the hammer 24 and the engagement between the convex portions and the protruding portions is thus released, the hammer 24 is rapidly accelerated in the rotation direction and in the forward direction and is moved forwards by the urging force of the spring 23 by the action of the cam mechanism and the elastic energy accumulated in the spring 23, in addition to the rotational force of the spindle 27, and the convex portions of the hammer are again engaged with the protruding portions of the anvil 30, which are then integrally rotated. At this time, since a powerful rotational striking force is applied to the anvil 30, the rotational striking force is transmitted to a screw, a bolt or the like through the tip tool (not shown) mounted in the angled hole portion 30d of the anvil 30. Thereafter, the same operation is repeatedly performed and thus the rotational striking force is intermittently and repeatedly transmitted from the tip tool to the screw, so that the screw is screwed into a material to be fastened (not shown) such as wood, for example.

The battery 9 of a pack type becoming a driving power source of the motor 3 is detachably mounted at a lower end portion of the handle part 2b. The battery 9 has therein a plurality of battery cells consisting of a lithium-ion secondary battery, a nickel-cadmium secondary battery and the like and is electrically coupled to the inverter circuit board 4 through the trigger switch 6 provided at a part of the handle part 2b. The inverter circuit board 4 is electrically coupled to coils (for example, star-connected three-phase coils) included in the stator 3b of the motor 3 and sequentially energizes predetermined phases to thus rotate the rotor 3a in a predetermined direction. An inverter circuit consisting of a known bridge circuit for energizing a driving current to the three-phase coils of the motor 3 is mounted on the inverter circuit board 4, and a control circuit consisting of a CPU and the like for controlling the inverter circuit is mounted on the control circuit board 8.

A switching mechanism that is used upon switching of the operating modes, i.e., the impact mode and the pulse mode is provided in the rear of the hammer 24, and a slide member 36, a stopper 41 and a pusher 45 are provided in the hammer case 32 and in the rear of the hammer 24. The slide member 36 is urged rearwards (towards the motor 3-side) by a switching spring 39 interposed between the slide member and a step part of the hammer case 32. A change lever 48b for operating the switching mechanism is provided on an outer side of the hammer case 32.

According to the impact tool 1 configured as described above, when the change lever 48b is operated to set the “impact mode”, which is the first operating mode, and an operator pulls the trigger 6a with griping the handle part 2b, the trigger switch 6 becomes on and the impact tool starts to operate. When the anvil 30 (the tip tool) is applied with load torque of a predetermined value or higher during the screw fastening, the hammer 24 gets on the anvil 30 by the action of the spring 23 and switches the rotational force into a striking force. Thereby, the hammer 24 can fasten the screw by applying the rotational striking force to the tip tool mounted to the anvil 30.

On the other hand, when the change lever 48b is operated to set the second operating mode, it is possible to set any one of an “electronic pulse mode”, a “clutch mode” and a “drill mode”, depending on a setting of an operating mode setting switch 11 (not shown in FIG. 1) provided for the housing 2. Upon the screw fastening in the “electronic pulse mode”, the rotational force of the forward/reverse rotation of the motor 3 transmitted from the rotation axis 3c is decelerated by the deceleration mechanism 20 having the planetary gear and the ring gear and is then transmitted to the spindle 27 and the hammer 24 applies the rotational striking force to the anvil 30 (the tip tool) during the screw fastening. The hammer 24 intends to move rearwards by the cam mechanism having the spindle cam recess 25, the hammer cam recess 28 and the balls 26 when the load torque of a predetermined value or larger is applied. However, since the retreating movement of the hammer 24 is restrained through the slide member 36 by the stopper 41, the hammer does not get on the anvil 30. For this reason, the forward or reverse rotation of the motor 3 is alternately and repeatedly controlled by a control means for controlling the rotation of the motor 3, so that the hammer 24 fastens the screw by applying the rotational striking force to the tip tool mounted to the anvil 30.

Subsequently, the outward appearance shapes of the housing 2 and the hammer case 32 will be described with reference to FIG. 2. In FIG. 2, the hammer case 32 is connected to a front side of the housing 2, and the hammer case 32 and the housing 2 configure the housing of the impact tool 1. The change lever 48b for switching the “first operating mode” and the “second operating mode” is provided on an upper part of the housing 2. The change lever 48b is configured to move circumferentially along an outer peripheral surface of the hammer case 32. Also, the trunk part 2a of the housing 2 has a recessed portion (a portion recessed rearwards from the front to the rear of the housing 2) defining a moving range of the change lever 48b. A change member 48 having the change lever 48b is arranged to enter an inside of the housing 2 near circumferential end portions 49a, 49b. That is, the housing 2 (an immovable member), the change lever 48b (a moveable member) and the hammer case 32 (an immovable member) are arranged to overlap in corresponding order from a diametrical outer side in the vicinity of an arrow A near the circumferential end portion 49b.

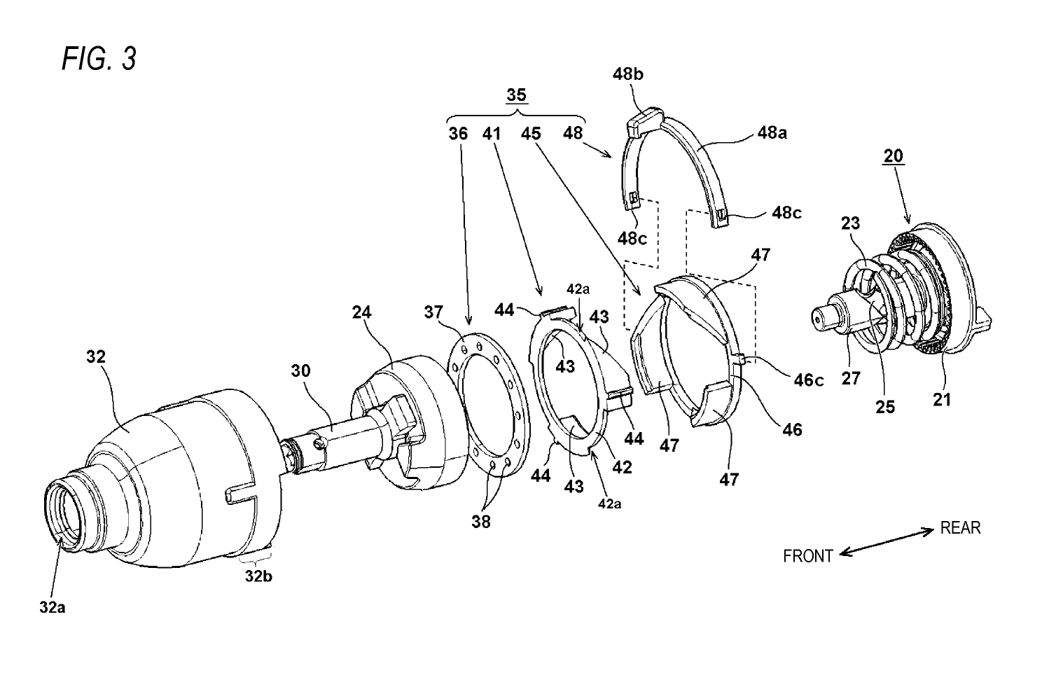

Subsequently, exploded configurations of the hammer case 32, the impact mechanism part and the switching mechanism 35 of this illustrative embodiment are described with reference to FIG. 3. Here, the switching mechanism 35 is provided between the deceleration mechanism 20 and the hammer 24. The switching mechanism 35 mainly consists of four members. The stopper 41 is moved forwards and rearwards in an axis direction to thus bring the slide member 36 arranged in front of the stopper 41 into contact with the hammer 24, thereby restraining the hammer 24 from moving rearwards in the axis direction. The pusher 45 is rotated in the rotation direction by 45° or larger, for example, about 67° to thus change a relative position to the stopper 41. The change member 48 is configured by engaging holes 48c formed at both end portions of a circular ring part 48a (a member having a shape formed by half cutting a ring-shaped member) and the change lever (an operating lever) 48b provided near a center between the two engaging holes 48c. As shown with the dotted line in FIG. 3, the engaging holes 48c are engaged with projecting portions 46c (only one is seen in FIG. 3) provided at two diametrically diagonal positions of the pusher 45. The hammer case 32 is manufactured by an integral molding of metal such as aluminum alloy. A distal end portion of the hammer case 32 has a forward tapered shape. The hammer case 32 includes a through-hole 32a, through which the anvil 30 passes. A flange part 32b is formed at a circumferential edge of a rear end opening of the hammer case 32 to hold the hammer case 32 such that the hammer case 32 is prevented from being separated forwards from the housing 2.

The hammer 24 has the same shape as that of the impact tool that has been widely used, and is attached to the spindle 27 via the cam mechanism. The spring 23 is provided in the rear of the hammer 24. The spring 23 is positioned inside the respective members of the switching mechanism 35, and the respective members of the switching mechanism 35 are arranged not to contact the spring 23. The change member 48 is arranged on the outer peripheral surface at the rear end of the hammer case 32, and a circular ring part 46 of the pusher 45 is arranged on the inner peripheral surface-side in the vicinity of the rear end portion of the hammer case 32. The change member 48 and the pusher 45 serve as a switching member performing the switching by the switching mechanism 35, and the stopper 41 serves as a member to be switched.

The slide member 36 is configured by a plurality of rollers 38 and a ring member 37 made of a synthetic resin and rotatably holding the rollers 38. Since the stopper 41 is not rotated relative to the hammer 24 rotating about a rotation axis of the output shaft, the slide member 36 is provided to prevent the stopper 41 from blocking the rotation of the hammer 24 at a state where the stopper 41 is moved forwards to thus block the retreating movement of the hammer 24. Therefore, the shape of the slide member 36 is not limited to the shape shown in the drawings and may be a bearing mechanism or slide mechanism having another shape inasmuch as it is a bearing member bearing a force (thrust) applied in the axis direction of the hammer 24, which is a rotary body.

The stopper 41 is a metallic member in which cam members 43 protruding rearwards from a circular ring part 42 are integrally provided at three portions in the circumferential direction of the circular ring part 42, and serves as a restraint member for restraining the hammer 24 from moving rearwards. In this illustrative embodiment, the stopper 41 is configured to move forwards and rearwards (to axially move) by the action of the pusher 45. At this time, however, the stopper is provided with spline projections 44 at three portions in the circumferential direction thereof so that the stopper is not rotated in the rotation direction. The spline projections 44 are engaged with spline recesses (not shown), which are formed on an inner wall of the hammer case 32 and are parallel in the axis direction, thereby permitting the stopper 41 to axially move but blocking the stopper 41 from moving in the rotation direction.

The pusher 45 is a member for moving the stopper 41 by pushing the stopper 41 from the rear towards the front in the axis direction, and is a metallic member in which cam members 47 protruding forwards from the circular ring part 46 are integrally provided at three portions. The pusher 45 is circumferentially rotatable about a rotation axis of the spindle 27 but does not axially move. The circumferential rotation of the pusher is performed as an operator operates the change lever 48b of the change member 48 connected to the pusher 45.

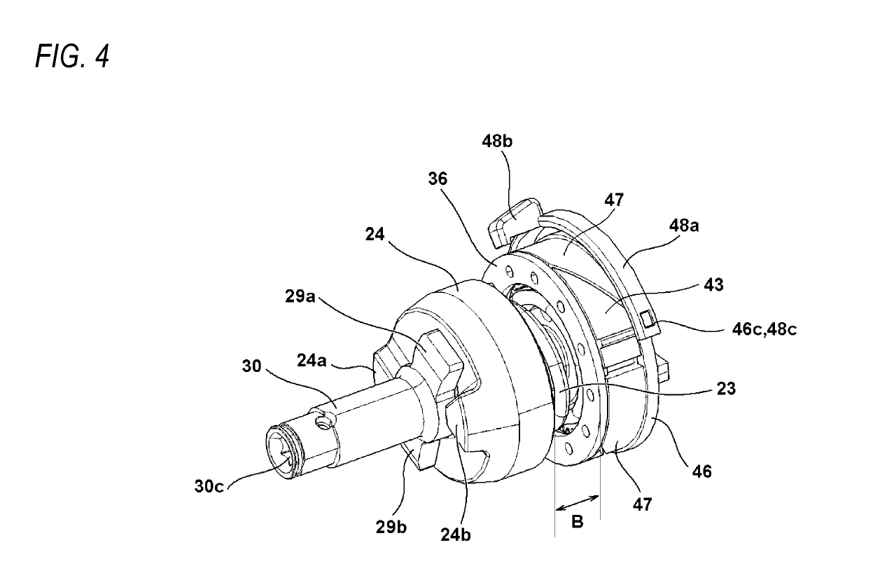

FIG. 4 is a perspective view of the striking mechanism part and the switching mechanism at a position of the first operating mode (a usual position). As can be seen from FIG. 4, a gap B between a front surface of the slide member 36 and a rear end surface of the hammer 24 is set to be sufficiently larger than axial lengths of protruding portions 29a, 29b on which the striking surface of the anvil 30 is formed. By this position relation, when the hammer 24 is retreated rearwards in the axis direction, convex portions 24a, 24b of the hammer 24 get beyond the protruding portions 29a, 29b of the anvil 30, so that a usual mechanical impact operation can be performed. At this time, the cam members 47 and the cam members 43 are alternately arranged side by side in the circumferential direction and a gap between the circular ring part 42 of the stopper 41 and the circular ring part 46 of the pusher 45 is shortest. In this way, the slide member 36 and the stopper 41 are located at the rear in the impact mode and the hammer 24 can be moved rearwards upon the driving.

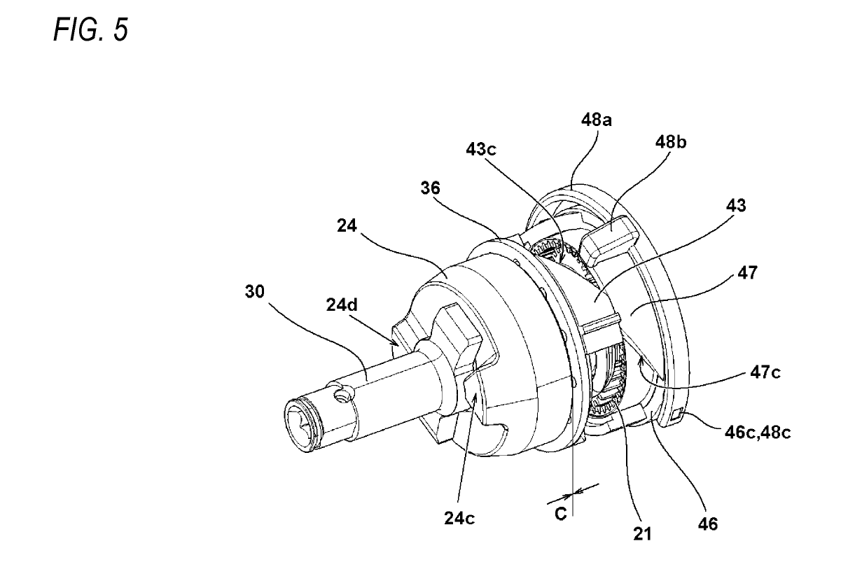

FIG. 5 is a perspective view of the striking mechanism part and the switching mechanism at a position of the second operating mode (a lock position). As can be seen from FIG. 5, a gap C between the front surface of the slide member 36 and the rear end surface of the hammer 24 is substantially zero. At this state, since the hammer 24 cannot retreat, it is not possible to perform the impact operation that is performed while the convex portions 24a, 24b of the hammer 24 get beyond the protruding portions 29a, 29b of the anvil 30. In order to perform the impact operation at this state, while the motor 3 is alternately and repeatedly rotated in the forward and reverse directions, the hammer 24 is enabled to strike the anvil 30 with moving relative to the anvil 30 only by a predetermined angle (smaller than 180°). At a state shown in FIG. 5, since rear end surfaces of the cam members 43 and front end surfaces of the cam members 47 abut on each other, the stopper 41 and the pusher 45 are axially arranged in series without overlapping with each other in the circumferential direction. Incidentally, in FIG. 5, the change lever 48b is not yet moved to the circumferential end portion 49a of the housing 2 (i.e., the change lever 48b is being moved) and a contact area between the rear end surfaces of the cam members 43 and the front end surfaces of the cam members 47 is somewhat small.

When changing the operating mode from the impact mode to the electronic pulse mode, the change lever 48b is circumferentially rotated and is thus switched from the state of FIG. 4 to the state of FIG. 5. Thereby, the rotation of the change lever 48b is transmitted to the pusher 45 through the projecting portions 46c, so that the pusher 45 is circumferentially rotated. In conjunction with the rotation, inclined surfaces 47c of the cam members 47 and inclined surfaces of the cam members 43 are slidingly moved relative to each other, so that the stopper 41 is moved forwards. As the stopper 41 is moved forwards, the slide member 36 is also moved forwards and fixed.

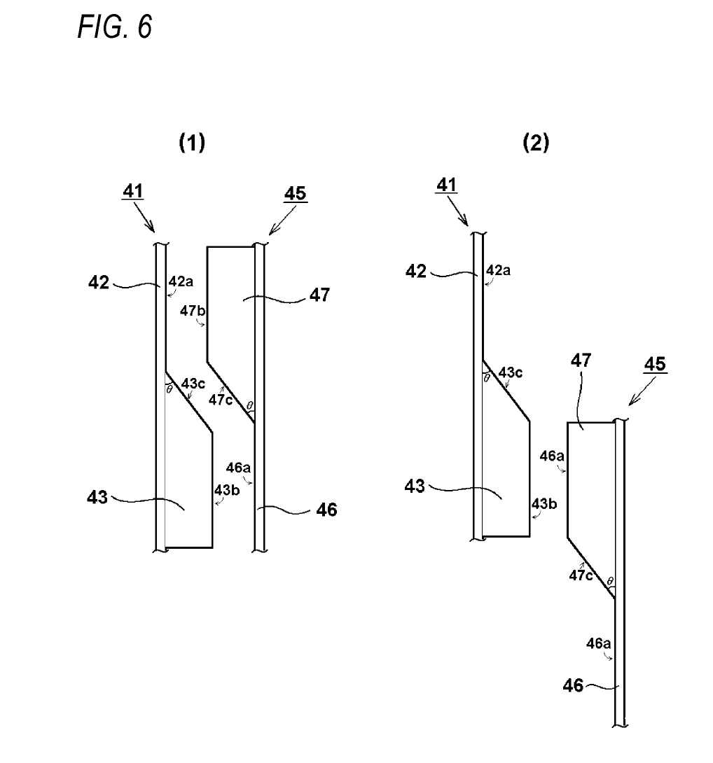

FIG. 6 is a pictorial view for illustrating the shapes of the stopper 41 and pusher 45 of the switching mechanism 35. FIG. 6(1) illustrates a relative position relation between the stopper 41 and the pusher 45 at the state of FIG. 4, and a one third part of a circumferential length is shown in a plan view for convenience of explanations. Although the stopper 41 and the pusher 45 are shown as if a gap is formed therebetween, they are actually arranged to contact, as shown in FIGS. 4 and 5. The stopper 41 is provided with the cam members 43 at three portions in the circumferential direction. The cam member 43 is a trapezoidal member having a lower-side bottom having contact with the circular ring part 42 and an upper-side bottom 43b opposite thereto. In the meantime, the pusher 45 also has a trapezoidal shape, and is provided with the cam members 47 at three portions in the circumferential direction. At the usual position shown in FIG. 4, since a planar part 42a of the circular ring part 42 abuts on a bottom part 47b and a planar part 46a of the circular ring part 46 abuts on the upper-side bottom 43b, it is possible to minimize the relative gap between the stopper 41 and the pusher 45.

FIG. 6(2) illustrates a relative position relation between the stopper 41 and the pusher 45 at the state of FIG. 5, and shows a state where the pusher 45 is rotated from the state of FIG. 6(1) by about 67°. When the pusher 45 is rotated from the state of FIG. 6(1), the pusher 45 is rotated with the inclined surface 43c and the inclined surface 47c contacting each other. Therefore, the stopper 41 is moved with being pushed forwards by the pusher 45. When the contact state between the inclined surface 43c and the inclined surface 47c is released, the upper-side bottom 43b and the planar part 46a abut on each other. At this state, a gap between the circular ring part 42 of the stopper 41 and the circular ring part 46 of the pusher 45 is twice as large as the state of FIG. 6(1). In this way, the rotatable pusher 45 is enabled to rotate relative to the non-rotating stopper 41, so that it is possible to axially move the stopper 41.

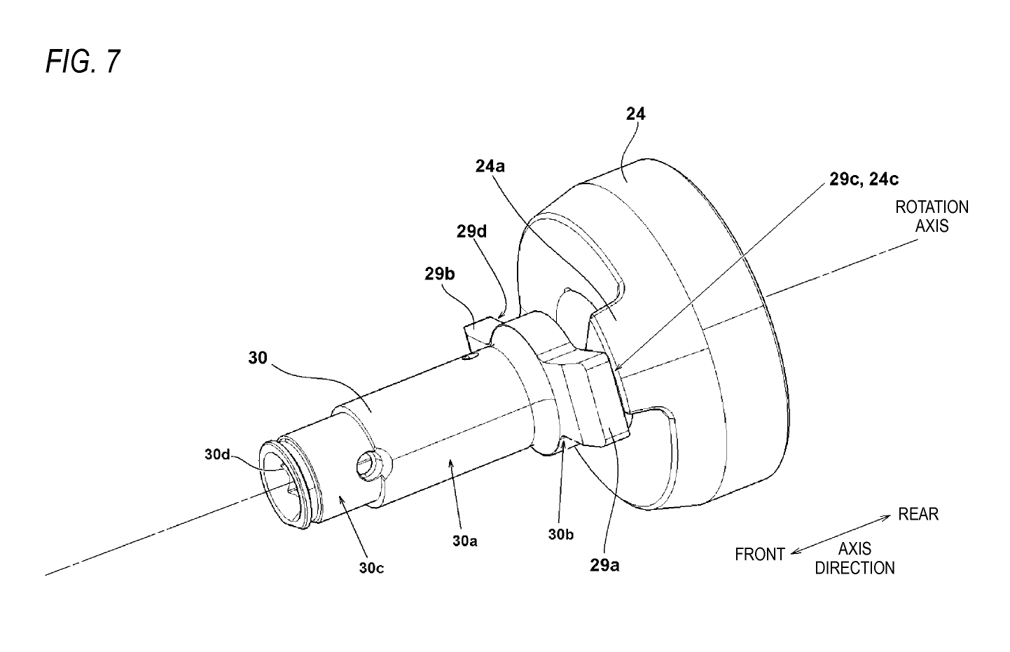

FIG. 7 illustrates a state where the hammer 24 stops with the hammer 24 getting on the anvil in the related-art impact tool. FIG. 7 shows a state where the protruding portions 29a, 29b as the striking part of the anvil 30 get on the convex portions 24a, 24b as the striking part of the hammer 24. The anvil 30 has a small diameter part 30c, which is slightly thinned so as to mount a tip tool at a front end-side of a cylindrical main body part 30a, and an angled hole portion 30d is formed at a front side of the small diameter part 30c. A large diameter part 30b whose diameter is thickened is formed at a rear side of the main body part 30a, and two protruding portions 29a, 29b protrude from the large diameter part 30b in a radially outward direction. The protruding portions 29a, 29b are striking claws having surfaces to be struck in a circumferential direction. Rear surfaces of the protruding portions 29a, 29b, i.e., rear surfaces 29c, 29d facing the hammer 24 are formed to be substantially perpendicular to the rotation axis of the output shaft.

The hammer 24 is formed with one set of the convex portions 24a, 24b axially protruding forwards from the cylindrical main body part. The convex portions 24a, 24b serve as striking claws having striking surfaces in the circumferential direction and are circumferentially spaced by 180°. Here, front surfaces of the convex portions 24a, 24b, i.e., front surfaces 24c, 24d (refer to FIG. 5) facing the anvil 30 are formed to be perpendicular to the rotation axis. When the hammer 24 having the above shape is rotated to strike the anvil 30, if an operator releases the trigger 6a upon ending of the operation, the motor 3 is stopped and the rotation of the hammer 24 is also stopped. At this time, when the motor 3 is stopped at the time that the convex portions 24a, 24b get beyond the protruding portions 29a, 29b, the rotation of the hammer 24 may be stopped at the state of FIG. 7, in some cases. During the stopping at this state, even when the operator tries to switch the operating mode from the first operating mode (the impact mode) to the second operating mode (any one of the electronic pulse mode, the clutch mode and the drill mode) by operating the change lever 48b, the switching mechanism is not operated, i.e., cannot be switched to the state of FIG. 5 because the hammer 24 h been retreated in the axial direction at the state of FIG. 7.

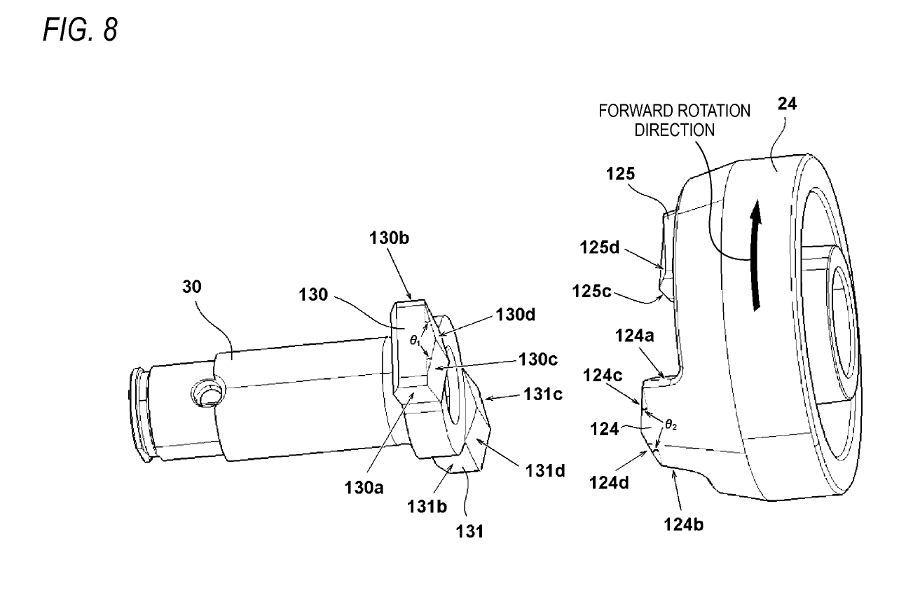

In view of the above problem, the illustrative embodiment improves shapes of rear end surface of protruding portions 130, 131 as the striking part of the anvil 30 and shapes of rear end surface of convex portions 124, 125 as the striking part of the hammer 24. FIG. 8 illustrates the shapes of the hammer 24 and the anvil 30 of an illustrative embodiment of the present invention. The rear end surfaces of the protruding portions 130, 131 of the anvil 30, i.e., the surfaces facing the hammer 24 are obliquely formed. Here, the rear end surfaces are formed to have a mountain shape having an inclined surface 130c and an inclined surface 130d and a mountain shape having an inclined surface 131c and an inclined surface 131d. All the inclined surfaces 130c, 130d, 131c, 131d are circumferentially inclined relative to a plane perpendicular to the rotation axis. Here, the rear end surfaces (the inclined surfaces 130c, 130d, 131c, 131d) are inclined by an angle θ₁ relative to the plane perpendicular to the rotation axis. Likewise, the front surfaces of the convex portions 124, 125 of the hammer 24, i.e., the surfaces facing the anvil 30 are formed to have a mountain shape. The mountain shape protrudes in an opposite direction to the rear end surface of the anvil 30, and the front end surface of the hammer 24 protrudes forwards. The inclined surfaces 124c, 124d, 125c, 125d are circumferentially inclined relative to the plane perpendicular to the rotation axis. Here, the front end surfaces (the inclined surfaces 124c, 124d, 125c, 125d) are inclined by an angle θ₂ relative to the plane perpendicular to the rotation axis. In this illustrative embodiment, the angles θ₁, θ₂ are preferably the same, and the angles θ₁, θ₂ are preferably about 2° to 15°. In this illustrative embodiment, the angles θ₁, θ₂ are set to be about 8°.

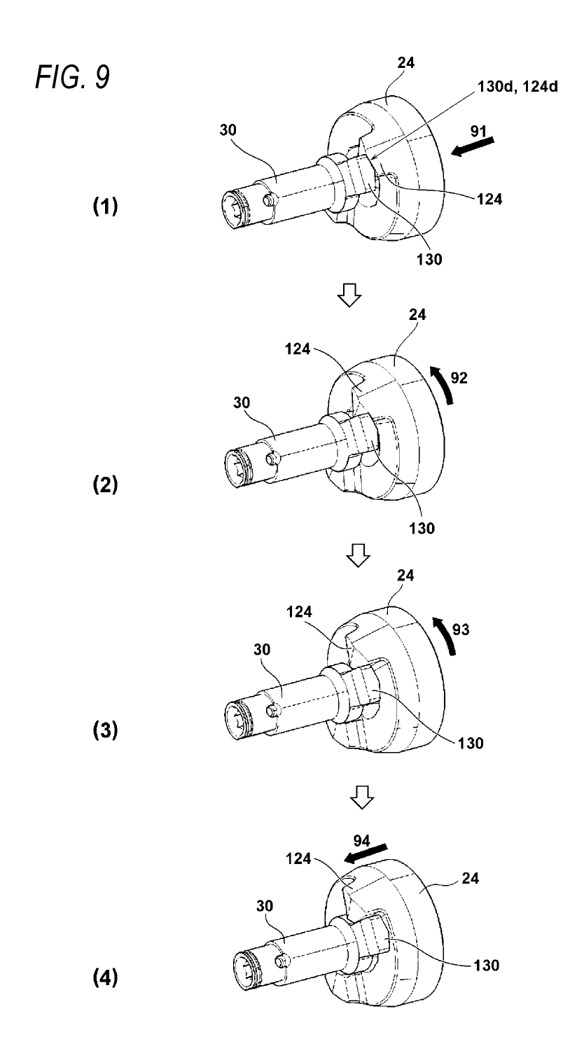

FIG. 9 is a perspective view illustrating the movements of the hammer 24 and the anvil 30 at four steps when the trigger 6a is released to stop the rotation of the motor 3. In this illustrative embodiment, it is assumed that the rotation of the motor 3 is stopped at a state of FIG. 9(1). At this time, although the rotational force from the motor 3, which is the driving source, is stopped, since the hammer 24 is retreated and spaced from the anvil 30 at the state of FIG. 9(1), the hammer 24 is applied with a strong forward urging force by the action of the spring 23 (refer to FIG. 3), as shown with an arrow 91. At this time, the inclined surfaces 130d, 124d are contacted to each other, and the inclined surfaces 131d, 125d are contacted to each other, which is not seen in FIG. 9. In this way, in this illustrative embodiment, since the facing surfaces of the hammer 24 and the anvil 30 are formed as the inclined surfaces, even after the motor 3 is stopped, the hammer 24 is rotated by the urging force of the spring 23, as shown with an arrow 92 of FIG. 9(2). When the hammer is further rotated, as shown with an arrow 93 of FIG. 9(3), it reaches a position at which the contacts states of the inclined surfaces 130d, 124d and the inclined surfaces 131d, 125d are released. Therefore, as shown in FIG. 9(4), the hammer 24 is moved forwards by the action of the spring 23, as shown with an arrow 94, and is then stopped. The state after the movement is the same as the state shown in FIG. 4.

As described above, according to the hammer 24 and the anvil 30 of the present invention, even when the hammer 24 and the anvil 30 are located at any relative rotating angle, the hammer 24 is all the time moved forwards and then stopped. Therefore, it is possible to securely avoid the problem that the switching mechanism of the fastening mode cannot be operated.

### Second Illustrative Embodiment

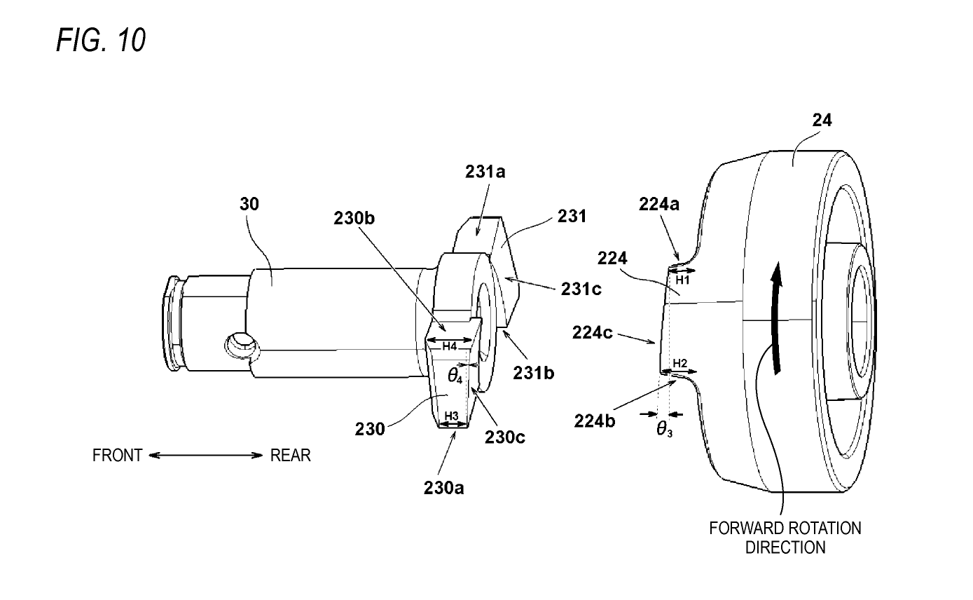

In the below, a second illustrative embodiment of the present invention is described with reference to FIGS. 10 to 12. The second illustrative embodiment is the same as the first illustrative embodiment, in that the respective axial facing surfaces of the striking part of the hammer and the striking part of the anvil are circumferentially obliquely formed relative to the plane perpendicular to the rotation axis. However, in the second illustrative embodiment, each of the facing surfaces consists of only one surface obliquely formed. The hammer 24 has a convex portion 224 protruding forwards from the cylindrical main body part in the axis direction (although the other convex portion 225 is not seen in FIG. 10, it is formed in a rotational symmetry relation with respect to the convex portion 224). The convex portions 224, 225 serve as striking claws having striking surfaces in the circumferential direction and are circumferentially spaced by 180°. Here, front surfaces of the convex portions 224, 225, i.e., the front surfaces 224c facing the anvil 30 are formed to be inclined by an angle θ₃ relative to the plane perpendicular to the rotation axis. As a result, an axial protruding length H1 of the convex portion 224 on a striking surface 224a in the forward rotation direction (a screw fastening direction) is shorter than an axial protruding length H2 of the convex portion 224 on a striking surface 224b in the reverse rotation direction (a screw unfastening direction).

Regarding the anvil 30, rear end surfaces of protruding portions 230, 231, i.e., surfaces facing the hammer 24 are obliquely formed. Here, the rear end surfaces are formed to have planar shapes consisting of inclined surfaces 230c, 231c. All the inclined surfaces 230c, 231c are circumferentially inclined relative to the plane perpendicular to the rotation axis. Here, the inclined surface 230c, which is the rear end surface, is formed to be inclined by an angle θ₄ relative to the plane perpendicular to the rotation axis. As a result, an axial protruding length H3 of the protruding portion 230 of striking surfaces 230a, 231a in the forward rotation direction (the screw fastening direction) is shorter than an axial protruding length H4 of the protruding portion 230 on a striking surface 230b in the reverse rotation direction (the screw unfastening direction). In the second illustrative embodiment, the angles θ₃, θ₄ are preferably the same, and the angles θ₃, θ₄ are preferably about 2° to 30°, more preferably about 2° to 15°. In this illustrative embodiment, the angles θ₃, θ₄ are set to be about 8°.

Also in the second illustrative embodiment, the hammer 24 is always moved forwards and then stopped, on the basis of the same principle as the operation principle described in FIG. 9. Therefore, even when the trigger 6a is released at any relative rotating angle state of the hammer 24 and the anvil 30, the hammer 24 is all the time moved forwards and then stopped. Therefore, it is possible to securely avoid the problem that the switching mechanism of the fastening mode cannot be operated after the motor is stopped. In the meantime, according to the present invention, in addition to the configuration where the respective axial facing surfaces of the striking part of the hammer and the striking part of the anvil are circumferentially obliquely formed relative to the plane perpendicular to the rotation axis, a configuration may be also possible where after the trigger 6a is released and the rotation of the motor 3 is thus stopped, the motor is supplied with a driving current for driving the motor in the reverse rotation direction (or a direction along which the overlapping state between the hammer and the anvil is released) for a short time, thereby moving forwards the hammer 24 and then stopping the same.

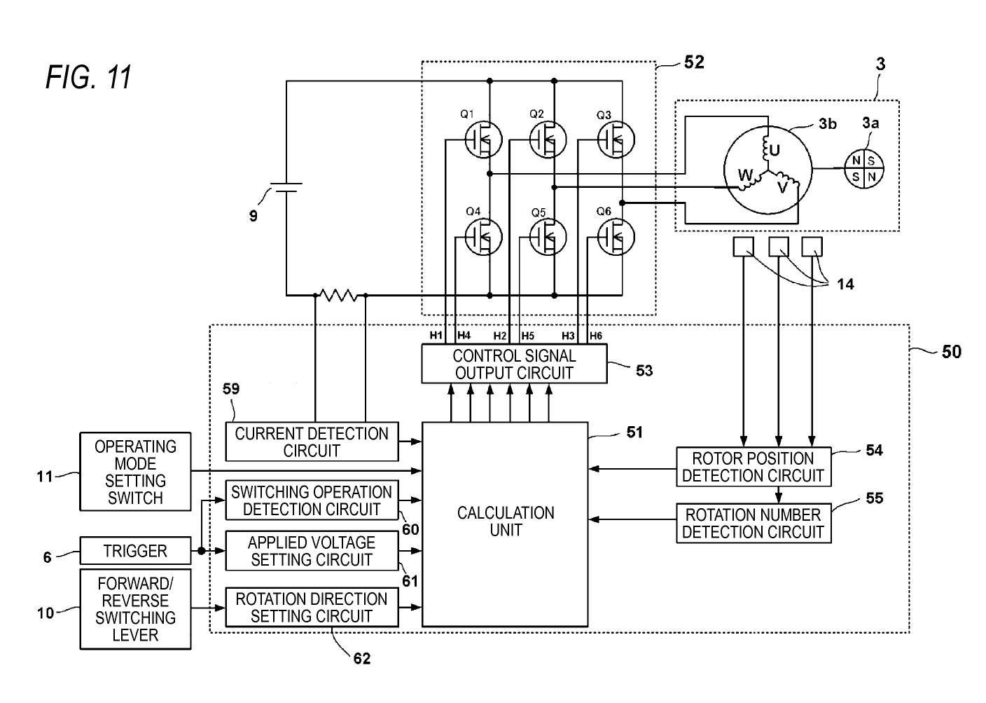

Here, a circuit of a drive control system performing the control of rotating the motor 3 in the reverse direction for a short time just after the trigger 6a is released is described with reference to FIG. 11. FIG. 11 is a block diagram showing a configuration of the drive control system of the motor. In this illustrative embodiment, the motor 3 consists of a three-phase brushless DC motor. The brushless DC motor includes a rotor 3a having permanent magnets including a plurality of sets (two sets, in this illustrative embodiment) N-poles and S-poles, a stator 3b having star-connected three-phase stator windings U, V, W and three rotation position detection elements (Hall elements) 14 for detecting a rotation position of the rotor 3a. The energization direction and time for the stator windings U, V, W are controlled on the basis of position detection signals from the rotation position detection elements 14, so that the motor 3 is rotated. The rotation position detection elements 14 are provided at positions facing the permanent magnets of the rotor 3a on the inverter circuit board 4.

An electronic element that is mounted on the inverter circuit board 4 includes six switching elements Q1 to Q6 such as FETs, which are connected in a three-phase bridge form. Each gate of the six bridge-connected switching elements Q1 to Q6 is coupled to a control signal output circuit 53 mounted on the control circuit board 8. Also, each source or drain of the six switching elements Q1 to Q6 is coupled to the star-connected stator windings U, V, W. Thereby, the six switching elements Q1 to Q6 perform a switching operation by switching element driving signals (driving signals such as H4, H5, H6 and the like) that are input from the control signal output circuit 53, and feed power to the stator windings U, V, W by using a direct current voltage of the battery 9 applied to the inverter circuit 52 as the three-phase (U phase, V phase and W phase) voltages Vu, Vv, Vw. A calculation unit 51 mounted on the control circuit board 8 changes a pulse width (a duty ratio) of a PWM signal on the basis of a detection signal of an operating amount (a stroke) of the trigger 6a of the trigger switch 6 to thus adjust a power feeding amount to the motor 3, thereby controlling the starting/stopping and rotating speed of the motor 3.

A rotation direction setting circuit 62 switches the rotation direction of the motor 3 whenever a change of the forward/reverse switching lever 10 is detected, and transmits a control signal thereof to the calculation unit 51. Although not shown, the calculation unit 51 includes a CPU for outputting a driving signal based on a processing program and data, a ROM for storing a processing program and control data, a RAM for temporarily storing data, a timer and the like. The control signal output circuit 53 generates a driving signal for alternately switching the predetermined switching elements Q1 to Q6, based on output signals of the rotation direction setting circuit 62, a rotor position detection circuit 54 and a rotation number detection circuit 55, and outputs the driving signal to the inverter circuit 52. A current value supplied to the motor 3 is measured by a current detection circuit 59, is fed back to the calculation unit 51 and is thus adjusted to be the set driving power.

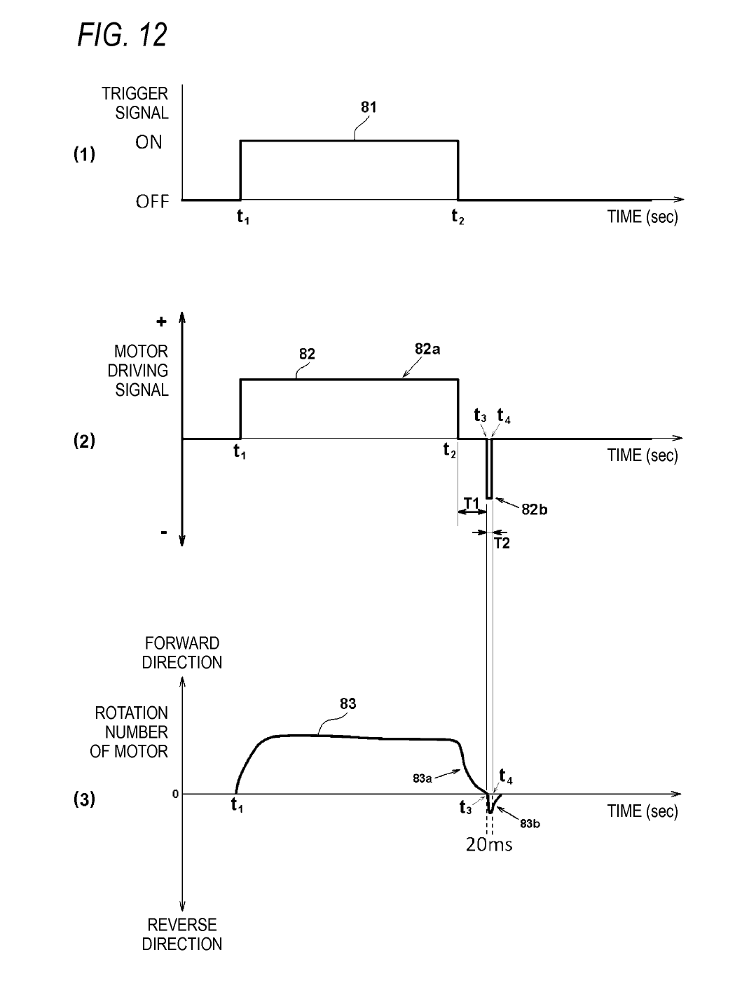

Like this, a control device 50 performing the rotation control by the inverter circuit 52 by using the brushless DC motor as the motor 3 is used to control the reverse rotation of the motor 3 for a short time when the trigger 6a is returned. FIG. 12 illustrates driving states of the motor 3 in the second illustrative embodiment, where FIG. 12(1) is a graph showing a state of the trigger 6a, FIG. 12(2) is a graph showing a driving signal from the inverter circuit 52 to the motor 3, and FIG. 12(3) is a graph showing a rotation number of the motor 3. In the respective graphs, a horizontal axis indicates time (sec) and a scale thereof is also shown. In FIG. 12(1), the impact tool 1 is operated at the first operating mode (the impact mode). When the trigger 6a is pulled at time t₁, the motor 3 starts to rotate. As shown with a trigger signal 81 that is an output of a switching operation detection circuit 60, an operator determines that the fastening operation is completed at time t₂, and releases the trigger 6a to thus end the operation. By the trigger operation, a driving signal 82 for rotating the motor 3 in a rotation direction designated by the forward/reverse switching lever 10 is output at time t₁ from the control signal output circuit 53 of the control device 50 to the inverter circuit 52, and the driving signal 82 is stopped at time t₂. Here, in this illustrative embodiment, after quiescent time T1 elapses from time t₂, a driving signal 82b for rotating the motor in the reverse direction for a short time period T2 from time t₃ to time t₄ is supplied to the inverter circuit 52, and the driving current is supplied from the inverter circuit 52 to the motor 3.

FIG. 12(3) shows a rotation number 83 of the motor 3 when the driving signal is supplied as shown with arrows 82a, 82b in FIG. 12(2). Even when the driving signal 82 is stopped at time t₂, the motor 3 does not immediately stop due to the inertia force, and the motor 3 then stops at time t₃. In this illustrative embodiment, the quiescent time T1 that is a short time period is preferably set to correspond to a time period after the trigger 6a is released until the motor 3 is stopped. The calculation unit 51 starts to reversely rotate the motor 3 from time t₃ after the quiescent time T1 elapses and immediately stops the rotation of the motor 3 at time t₄. From time t₃ to time t₄, the motor 3 is rotated in the reverse direction so that the hammer 24 is always moved forwards and then stopped by applying not only the forces of the inclined surfaces 230c, 231c, 224c, 225c and the spring 23 but also the driving force of the motor 3, when the hammer 24 gets on the anvil 30, as shown in FIG. 7. Therefore, in this illustrative embodiment, the driving time of the motor 3 indicated with the arrow 82b may be a time period for which a pulse voltage is applied, and a time period t₃ to t₄ is about 20 milliseconds, for example.

The rotation of the motor 3 shown in FIG. 12(2) is controlled by the calculation unit 51. Regarding a time interval of the quiescent time T1 and the driving time T2 of the reverse rotation, optimal values thereof may be set by a test and the like and is preferably stored beforehand in a storage device included in the calculation unit 51. Incidentally, the rotation control described with reference to FIG. 12 may be performed for not only the hammer and the anvil having the shapes shown in FIG. 10 but also the hammer and the anvil having the shapes shown in FIG. 8 in the same manner. In this case, when the trigger 6a is returned, the short driving of about 20 milliseconds such as quiescent time-reverse rotation driving-quiescent time-forward rotation driving may be applied in both the forward/reverse rotation directions. Also, in the example of FIG. 12, the motor 3 is rotated in the reverse direction from time t₃ to time t₄. However, the rotation direction of driving the motor for a short time in conformity to the shapes of the facing inclined surfaces of the hammer and the anvil may be arbitrarily set. For example, as for the hammer and the anvil having the shapes shown in FIG. 10, the motor may be configured to always rotate in the reverse direction from time t₃ to time t₄, irrespective of whether the rotation direction from time t₁ to time t₂ is the forward rotation direction or reverse rotation direction.

In the second illustrative embodiment, not only the shapes of the hammer and the anvil are improved but also the motor 3 is controlled to rotate in the reverse direction for a short time upon the stopping of the motor. Therefore, it is possible to implement the configuration where after the trigger 6a is released, the hammer 24 is always moved forwards and is then stopped. For this reason, it is possible to smoothly operate the switching mechanism blocking the retreating movement of the hammer 24 after the motor 3 is stopped, so that it is possible to implement the impact tool having good usability. Incidentally, it may be possible to also obtain the same effects in the impact tool using the hammer and the anvil of the related art shown in FIG. 7 just by controlling the motor 3 to rotate in the forward or reverse direction for a short time upon the stopping of the motor 3, depending on the shapes of the hammer and the anvil.

Hereinabove, although the present invention has been described with reference to the illustrative embodiments, the present invention is not limited to the above-described illustrative embodiments but can be variously modified without departing from the scope of the present invention. For example, in the above-described illustrative embodiments, the facing surfaces of the hammer and the anvil are formed as the obliquely formed planar surfaces (inclined surfaces). Alternative to the inclined surfaces, the facing surfaces may be formed as curved surfaces. That is, the facing surfaces may be arbitrarily shaped so long as the hammer is not stopped with the convex portions of the hammer getting on the protruding portions of the anvil. Further, in the above-described illustrative embodiments, the electric tool capable of using both functions of the impact tool and the electronic pulse driver has been exemplified. However, a tool having functions of the impact tool and a driver drill is also possible. Further, in the above-described illustrative embodiments, the electric tool using the brushless DC motor as the driving source has been exemplified as the impact tool. However, an electric tool using a motor having a brush and an impact tool using an air motor are also possible.

Thus, as has been described heretofore, the following matters are disclosed in this specification.

The impact tool may further comprise a restraint member for restraining the hammer from moving in an opposite direction to the anvil, wherein a first operating mode (a mode in which a mechanical impact operation is performed) in which the movement of the hammer is not restrained and a second operating mode (a mode in which an impact operation is performed by an electronic pulse method, a drill mode or an electronic clutch mode) in which the movement of the hammer is restrained can be switched by means of the restraint member. In the second operating mode, a striking operation of rotating the hammer in a forward or reverse direction by a rotating angle that is smaller than 180° relative to the anvil is performed. Although the restraint member is operated upon the stopping of the motor, the hammer is always moved forwards and is then stopped upon the stopping of the motor. Therefore, it is possible to securely avoid the problem that the switching operation cannot be performed.

The facing surfaces of the striking parts of the hammer and the anvil may be formed to have one or two inclined surfaces that are inclined in a circumferentially opposite direction relative to the plane perpendicular to the rotation axis. Therefore, even when the hammer is rotated in the forward or reverse direction, it is possible to forward move the hammer by the action of the spring upon the stopping of the motor. The striking part of the hammer may be a convex portion protruding from the hammer towards the anvil, and the striking part of the anvil may be a protruding portion protruding diametrically from a cylindrical main body part. The inclined surface may be formed such that, regarding an axial protruding length of the convex portion, a protruding length of a striking surface upon a forward rotation is shorter than a protruding length of a striking surface upon a reverse rotation. In this way, the protruding lengths are set, so that the hammer getting on the anvil is enabled to easily slide down in a specific direction.

The impact tool may further comprise a trigger for rotating the motor and a control device configured to, just after the trigger is returned and the motor is thus stopped, supply a driving current to the motor for a short time period to thus slightly rotate the hammer in a predetermined rotation direction. Therefore, it is possible return the hammer from the getting-on state not only by the shapes of the hammer and anvil but by the electric control of the motor.

The impact tool may further comprise a forward/reverse changeover switch for setting a rotation direction of the motor, and the control device may be configured to supply the pulse voltage for driving the motor in an opposite direction to a rotation direction set by the forward/reverse changeover switch. Therefore, it is possible to effectively return the hammer from the getting-on state, depending on the rotation direction.

This application claims the benefit of Japanese Patent Application No. 2013-156181 filed on Jul. 26, 2013, the disclosure of which is incorporated herein in its entirety by reference.

### INDUSTRIAL APPLICABILITY

As described above, the impact tool according to the present invention has advantages of improving shapes of a hammer and an anvil, thereby preventing a motor from stopping at a state where a striking part of the hammer gets on a striking part of the anvil upon stopping of the motor. The present invention is useful for the impact tool, for example.

### REFERENCE SIGNS LIST

1: impact tool

2: housing

2a: trunk part

2b: handle part

3: motor

3a: rotor

3b: stator

3c: rotation axis

4: inverter circuit board

5: switching element

6: trigger switch

6a: trigger

7: switch board

8: control circuit board

9: battery

10: forward/reverse switching lever

11: operating mode setting switch

13: rotor fan

14: rotation position detection element

17a: air inlet

17b, 17c: slot

18a, 18b: bearing

19a: metal

19b: bearing

20: deceleration mechanism

22: rotational striking mechanism part

23: spring

24: hammer

24a, 24b: convex portion

24c, 24d: front surface

25: spindle cam recess

26: ball

27: spindle

28: hammer cam recess

29a, 29b: protruding portion

29c, 29d: rear surface

30: anvil

30a: main body part (middle diameter part)

30b: large diameter part

30c: small diameter part

30d: angled hole portion

31: attaching member

32: hammer case

32a: through-hole

32b: flange part

35: switching mechanism

36: member

37: ring member

38: roller

39: switching spring

41: stopper

42: circular ring part

42a: planar part

43, 47: cam member

43b, 47b: upper-side bottom (of cam member)

43c, 47c: inclined surface (of cam member)

44: spline projection

45: pusher

46: circular ring part

46a: planar part

46c: projecting portion

48: change member

48a: circular ring part

48b: change lever (operating part)

48c: engaging hole

49a, 49b: circumferential end portion

50: control device

51: calculation unit

52: inverter circuit

53: control signal output circuit

54: rotor position detection circuit

55: rotation number detection circuit

59: current detection circuit

60: switching operation detection circuit

62: rotation direction setting circuit

81: trigger signal

82: driving signal

82b: driving signal

83: rotation number

124: convex portion

124c: inclined surface

130: protruding portion

130c, 130d: incline surface

131c, 131d: incline surface

224: convex portion

224a, 224b: striking surface

224c: front surface

225: convex portion

230: protruding portion

230a, 230b: striking surface

230c: incline surface

1. An impact tool comprising:
a motor;
a spindle that is rotated by the motor;
a hammer that is moved in an axis direction of the spindle while being rotated by an action of a cam mechanism provided for the spindle;
an anvil to which a rotational force and a striking force are applied by the hammer, and
a spring configured to urge the hammer towards the anvil,
wherein facing surfaces of a striking part of the hammer and a striking part of the anvil in a direction of a rotation axis of an output shaft are respectively formed to be circumferentially oblique relative to a plane perpendicular to the rotation axis.

2. The impact tool according to claim 1, further comprising a restraint member for restraining the hammer from moving in an opposite direction to the anvil,
wherein a first operating mode in which the movement of the hammer is not restrained and a second operating mode in which the movement of the hammer is restrained are switched by means of the restraint member.

3. The impact tool according to claim 2, wherein the second operating mode comprises performing a striking operation of rotating the hammer in a forward or reverse direction by a rotating angle smaller than 180° relative to the anvil.

4. The impact tool according to claim 1, wherein the facing surfaces are formed to have two inclined surfaces that are inclined in a circumferentially opposite direction relative to the plane perpendicular to the rotation axis.

5. The impact tool according to claim 1, wherein each of the facing surfaces are formed to have one inclined surface that is inclined circumferentially relative to the plane perpendicular to the rotation axis.

6. The impact tool according to claim 5,
wherein the striking part of the hammer is a convex portion protruding from the hammer towards the anvil, and
wherein the striking part of the anvil is a protruding portion extending diametrically from a cylindrical main body part.

7. The impact tool according to claim 6, wherein the inclined surface is formed such that, regarding an axial protruding length of the convex portion, a protruding length of a striking surface upon a forward rotation is shorter than a protruding length of a striking surface upon a reverse rotation.

8. The impact tool according to claim 1, further comprising:
a trigger for rotating the motor; and
a control device configured to, just after the trigger is returned and the motor is thus stopped, supply a driving current to the motor for a short time period to thus slightly rotate the hammer in a predetermined rotation direction.

9. An impact tool comprising:
a motor;
a trigger rotating the motor;
a spindle that is rotated by the motor;
a hammer that is moved in an axis direction of the spindle while being rotated by an action of a cam mechanism provided for the spindle;
an anvil to which a rotational force and a striking force are applied by the hammer; and
a spring that urges the hammer towards the anvil,
wherein the impact tool further comprises a control device configured to supply a short pulse voltage for driving the motor after a short time period from a release of the trigger.

10. The impact tool according to claim 9, further comprising a forward/reverse changeover switch for setting a rotation direction of the motor,
wherein the control device is configured to supply the pulse voltage for driving the motor in an opposite direction to a rotation direction set by the forward/reverse changeover switch.

11. The impact tool according to claim 4,
wherein the striking part of the hammer is a convex portion protruding from the hammer towards the anvil, and
wherein the striking part of the anvil is a protruding portion extending diametrically from a cylindrical main body part.

12. The impact tool according to claim 11, wherein the inclined surface is formed such that, regarding an axial protruding length of the convex portion, a protruding length of a striking surface upon a forward rotation is shorter than a protruding length of a striking surface upon a reverse rotation.
